(19) United States
(12) Patent Application Publication
(10) Pub. No.: US 2008/0246833 A1
(43) Pub. Date: Oct. 9, 2008

(54) VIDEO CONFERENCING APPARATUS, CONTROL METHOD, AND PROGRAM

(76) Inventors: Hiroyuki YASUI, Kanagawa (JP); Takayoshi Kawaguchi, Kanagawa (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/062,335

(22) Filed: Apr. 3, 2008

(30) Foreign Application Priority Data
Apr. 6, 2007 (JP) P2007-100121

(51) Int. Cl. H04N 7/14

(52) U.S. Cl. 348/14.08; 348/14.16; 381/92; 348/E07.082; 348/E07.083

(57) ABSTRACT

A video conferencing apparatus for video conferencing includes: a light emission control means for allowing a light emitting means for emitting a light that is included in a sound collecting means for collecting a sound to emit a light in a certain light emission pattern; a light emitting position detecting means for detecting a light emitting position that is a position of the light in an image obtained by imaging the light from the light emitting means included in the sound collecting means by a first imaging means for imaging; an arranging direction detecting means for detecting an arranging direction that is a direction in which the sound collecting means is arranged based on the light emitting position; and an imaging control means for controlling an imaging direction that is a direction in which a second imaging means for imaging an image takes an image, based on the arranging direction.

### CROSS REFERENCES TO RELATED APPLICATIONS

The present invention contains subject matter related to Japanese Patent Application JP 2007-100121 filed in the Japanese Patent Office on Apr. 6, 2007, the entire contents of which being incorporated herein by reference.

### BACKGROUND OF THE INVENTION

1. Field of the Invention

The present invention relates to a video conferencing apparatus, a control method, and a program, particularly to a video conferencing apparatus, a control method, and a program, which enables automatic settings of imaging information such as an imaging direction to image a speaker in a video conference, for instance.

2. Description of the Related Art

For example, in a video conferencing apparatus used for video conferencing, a camera of the video conferencing apparatus is controlled so that an image of a speaker in talking is taken in a predetermined size, and the taken image obtained by the camera is sent to a video conferencing apparatus of the communicating party.

For example, JP-A-7-92988 (Patent Reference 1) discloses a video switching apparatus that controls a camera so that video is switched to imaging the pictures at the position of a microphone detecting sounds (particularly, see paragraphs [0057], [0059], and [0060] in Patent Reference 1).

### SUMMARY OF THE INVENTION

However, in the video switching apparatus disclosed in Patent Reference 1, it is necessary to manually set the positions of the individual microphones in advance. In addition, in the case in which the positions of the individual microphones are changed, it is necessary for a user to again manually set the positions of the individual microphones after changed.

It is desirable to enable automatic settings of imaging information such as an imaging direction to image a speaker.

A video conferencing apparatus, or a program according to an embodiment of the invention is a video conferencing apparatus for video conferencing, or a program that allows a computer to function as a video conferencing apparatus for video conferencing, the video conferencing apparatus including: a light emission control means for allowing a light emitting means for emitting a light that is included in a sound collecting means for collecting a sound to emit a light in a certain light emission pattern; a light emitting position detecting means for detecting a light emitting position that is a position of the light in an image obtained by imaging the light from the light emitting means included in the sound collecting means by a first imaging means; an arranging direction detecting means for detecting an arranging direction that is a direction in which the sound collecting means is arranged based on the light emitting position; and an imaging control means for controlling an imaging direction that is a direction in which a second imaging means for imaging an image takes an image, based on the arranging direction.

The first imaging means may image a low resolution image, and the second imaging means may image a high resolution image.

The first and second imaging means may be the same.

The light emission control means may allow each of a plurality of the light emitting means that is included in the sound collecting means to emit a light in a predetermined order, or may allow each of a plurality of the light emitting means that is included in the sound collecting means to emit a light in individual light emission patterns simultaneously, the light emitting position detecting means may detect the light emitting position for each of the plurality of the sound collecting means, the arranging direction detecting means may detect the arranging direction of each of the plurality of the sound collecting means, based on the light emitting position, and the imaging control means may control the imaging direction based on the arranging direction of a sound collecting means that is collecting a sound at a high level in the plurality of the sound collecting means.

The video conferencing apparatus according to the embodiment of the invention may further include: a distance computing means for computing a distance between the sound outputting means and the sound collecting means from a timing at which the sound collecting means collects a predetermined sound that is outputted from a sound outputting means for outputting a predetermined sound and a timing at which the sound outputting means outputs the predetermined sound, wherein the imaging control means also controls a magnification at the time of imaging by the second imaging means based on a distance between the sound outputting means and the sound collecting means.

In the video conferencing apparatus according to the embodiment of the invention, one or more of the sound collecting means, the first imaging means, and the second imaging means may be provided in plural.

A control method according to an embodiment of the invention is a method of controlling a video conferencing apparatus for video conferencing, the method including the steps of: allowing a light emitting means for emitting a light that is included in a sound collecting means for collecting a sound to emit a light in a certain light emission pattern; detecting a light emitting position that is a position of the light in an image obtained by imaging the light from the light emitting means included in the sound collecting means by a first imaging means; and detecting an arranging direction that is a direction in which the sound collecting means is arranged based on the light emitting position, wherein in the video conferencing apparatus, an imaging direction that is a direction in which a second imaging means for imaging an image takes an image is controlled based on the arranging direction.

According to the embodiment of the invention, the light emitting means for emitting a light that is included in the sound collecting means for collecting a sound is allowed to emit a light in the certain light emission pattern, the light emitting position that is a position of the light in the image obtained by imaging the light from the light emitting means included in the sound collecting means by the first imaging means is detected, and the arranging direction that is a direction in which the sound collecting means is arranged is detected based on the light emitting position. Then, the imaging direction that is a direction in which the second imaging means for imaging an image takes an image is controlled based on the arranging direction.

According to the embodiment of the invention, imaging information such as an imaging direction to image a speaker in a video conference can be set automatically.

### BRIEF DESCRIPTION OF THE DRAWINGS

FIG. 1 shows a block diagram depicting an exemplary configuration of a video conferencing system to which an embodiment of the invention is adapted;

FIG. 2 shows a block diagram depicting an exemplary configuration of a first embodiment of a video conferencing apparatus 11 configuring the video conferencing system shown in FIG. 1;

FIG. 3 shows a block diagram depicting an exemplary configuration of a control part 32a that is functionally implemented by a CPU 32 shown in FIG. 2 running a predetermined program;

FIG. 4 shows a diagram illustrative of a light emitting position detecting process in which a light emitting position detecting part 101 shown in FIG. 3 detects a light emitting position (x, y);

FIG. 5 shows a flow chart illustrative of an arranging direction detecting process that detects the directions of arranging microphones 37 to 39;

FIG. 6 shows a flow chart illustrative of a camera control process that controls a camera 34;

FIG. 7 shows a block diagram depicting an exemplary configuration of a second embodiment of the video conferencing apparatus 11 configuring the video conferencing system shown in FIG. 1;

FIG. 8 shows a block diagram depicting an exemplary configuration of a control part 232a that is functionally implemented by a CPU 32 shown in FIG. 7 running a predetermined program;

FIG. 9 shows a diagram illustrative of a method of computing the distance between the speaker 203 and each of the microphones 37 to 39 performed by a distance computing part 301 shown in FIG. 8;

FIG. 10 shows a flow chart illustrative of a zooming factor computing process that computes the magnification of the camera 34;

FIG. 11 shows a diagram depicting a video conferencing apparatus 401 and a directing device 402 that controls the video conferencing apparatus 401 based on the light emitted from an LED;

FIG. 12 shows a block diagram depicting an exemplary configuration of a control part 432a that is functionally implemented by a CPU 432 shown in FIG. 11 running a predetermined program; and

FIG. 13 shows a flow chart illustrative of a remote control process that remotely controls the video conferencing apparatus 401.

### DETAILED DESCRIPTION OF THE INVENTION

Hereinafter, an embodiment of the invention will be described. The following is examples of the correspondence between configuration requirements for the invention and the embodiments of the specification or the drawings. This is described for confirming that the embodiments supporting the invention are described in the specification or the drawings. Therefore, even though there is an embodiment that is described in the specification or the drawings but is not described herein as an embodiment corresponding to configuration requirements for the invention, it does not mean that the embodiment does not correspond to those configuration requirements. Contrary to this, even though an embodiment is described herein as an embodiment corresponding to configuration requirements, it does not mean that the embodiment does not correspond to configuration requirements other than those configuration requirements.

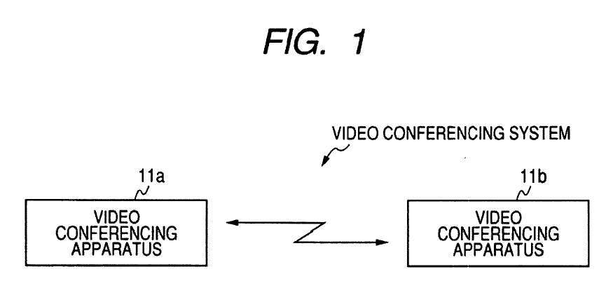

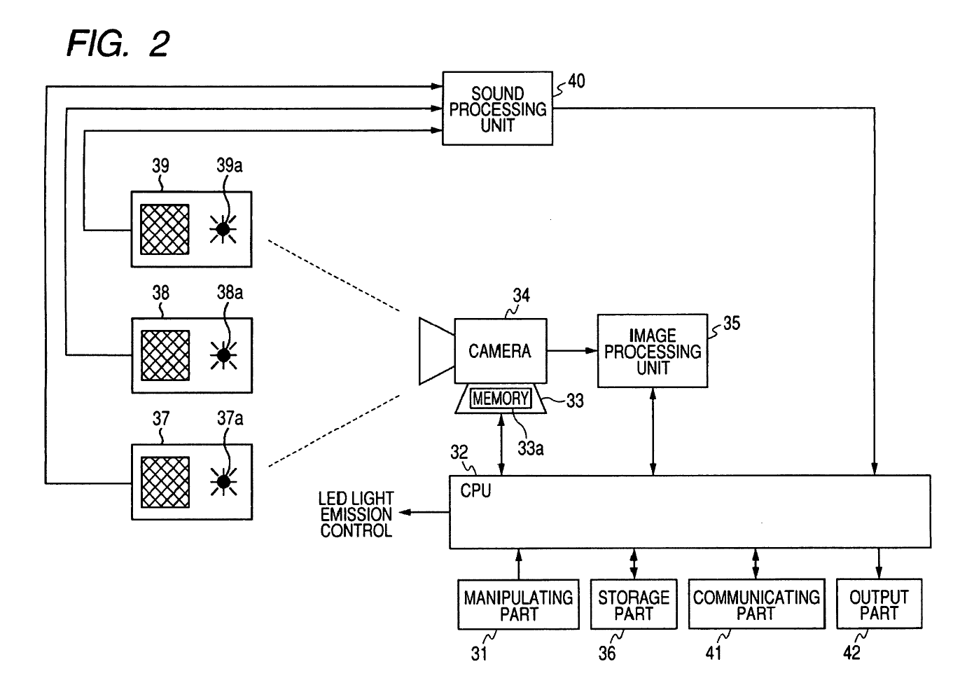

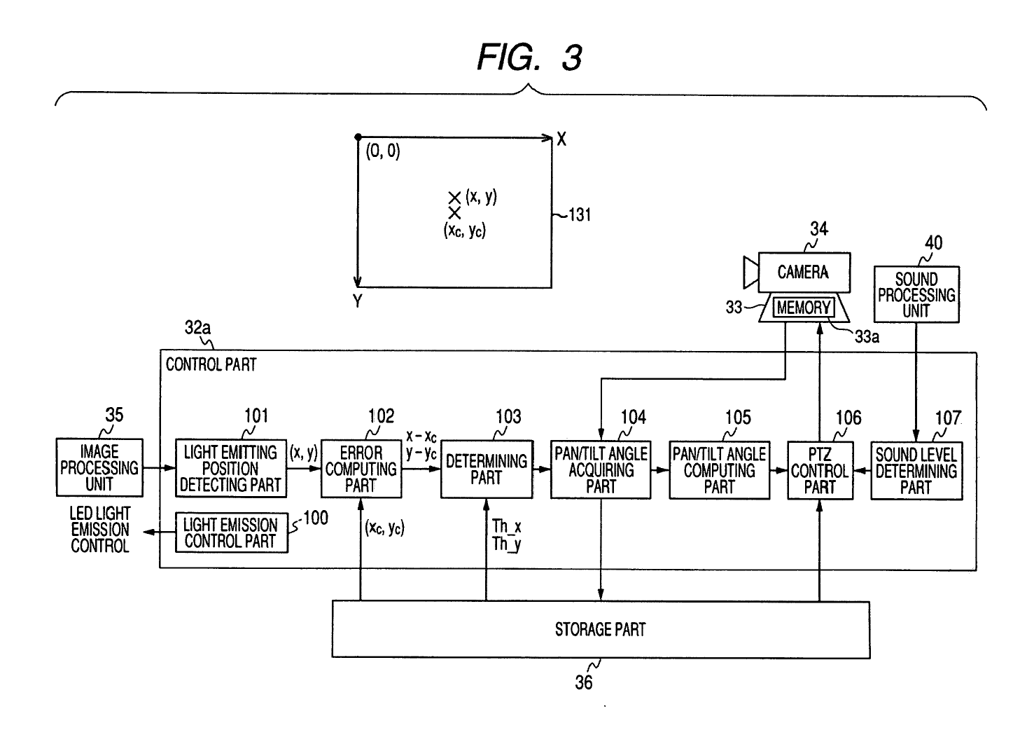

A video conferencing apparatus, or a program according to an embodiment of the invention is a video conferencing apparatus for video conferencing (for example, a video conferencing apparatus 11a or 11b shown in FIG. 1), or a program that allows a computer to function as a video conferencing apparatus for video conferencing, the video conferencing apparatus includes: a light emission control means (for example, a light emission control part 100 shown in FIG. 3) for allowing a light emitting means (for example, an LED 37a, 38a, or 39a shown in FIG. 2) for emitting a light that is included in a sound collecting means (for example, a microphone 37, 38 or 39 shown in FIG. 2) for collecting a sound to emit a light in a certain light emission pattern; a light emitting position detecting means (for example, a light emitting position detecting part 101 shown in FIG. 3) for detecting in an image obtained by a first imaging means (for example, a camera 34 shown in FIG. 2) for imaging an image which takes a light from the light emitting means that is included in the sound collecting means, a light emitting position that is a position of the light; an arranging direction detecting means (for example, a pan/tilt angle acquiring part 104 shown in FIG. 3) for detecting an arranging direction that is a direction in which the sound collecting means is arranged based on the light emitting position; and an imaging control means (for example, a PTZ control part 106 shown in FIG. 3) for controlling an imaging direction that is a direction in which a second imaging means (for example, the camera 34 shown in FIG. 2) for imaging an image takes an image, based on the arranging direction.

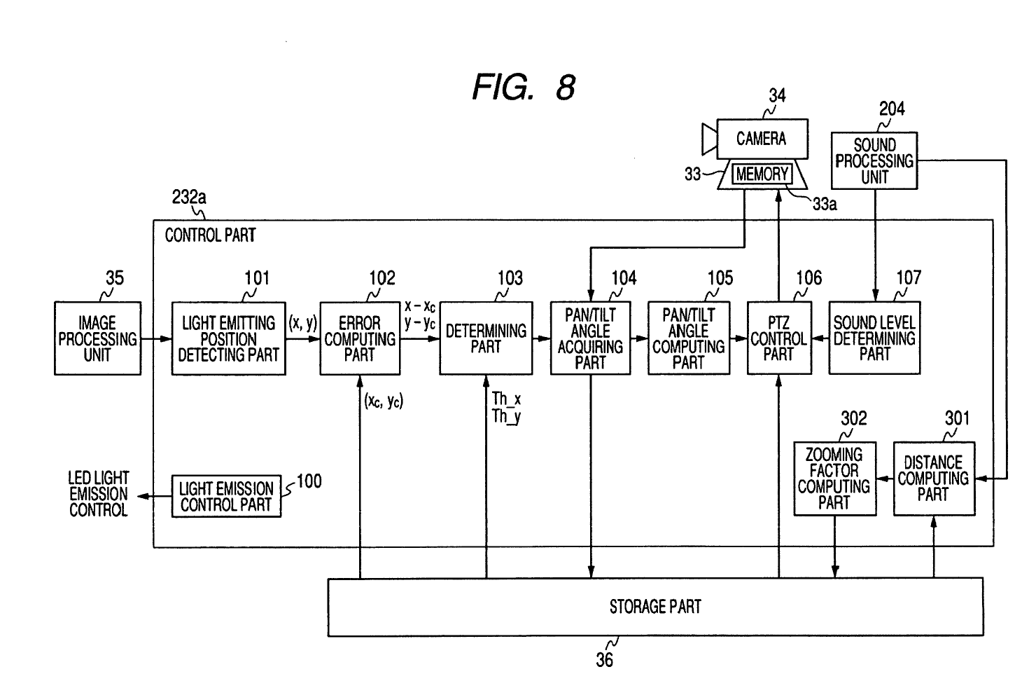

The video conferencing apparatus according to the embodiment of the invention may further include: a distance computing means (for example, a distance computing part 301 in FIG. 8) for computing a distance between the sound outputting means and the sound collecting means from a timing at which the sound collecting means collects a predetermined sound that is outputted from a sound outputting means for outputting a predetermined sound and a timing at which the sound outputting means outputs the predetermined sound, wherein the imaging control means also controls a magnification at the time of imaging by the second imaging means based on a distance between the sound outputting means and the sound collecting means.

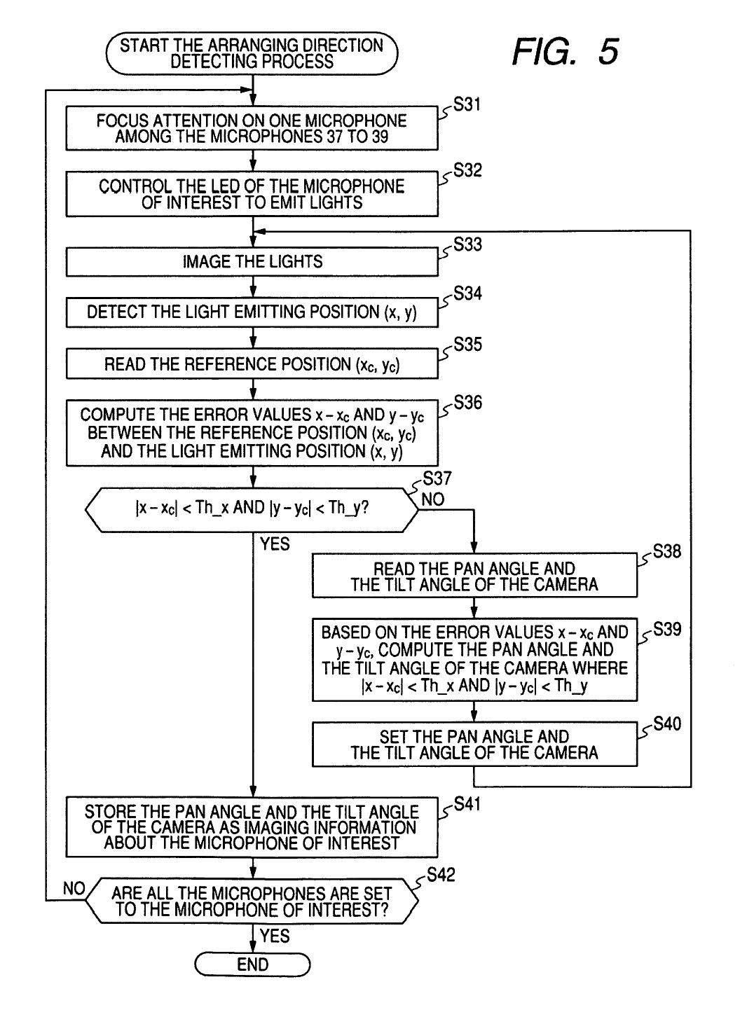

A control method according to an embodiment of the invention is a method of controlling a video conferencing apparatus for video conferencing, the method including the steps of: allowing a light emitting means for emitting a light that is included in a sound collecting means for collecting a sound (for example, Step S32 shown in FIG. 5) to emit a light in a certain light emission pattern; detecting a light emitting position that is a position of the light in an image (for example, Step S34 shown in FIG. 5) obtained by imaging the light from the light emitting means in the sound collecting means by a first imaging means; and detecting an arranging direction that is a direction in which the sound collecting means is arranged based on the light emitting position (for example, Step S41 shown in FIG. 5), wherein in the video conferencing apparatus, an imaging direction that is a direction in which a second imaging means for imaging an image takes an image is controlled based on the arranging direction.

Hereinafter, embodiments of the invention will be described with reference to the drawings.

FIG. 1 shows a block diagram depicting an exemplary configuration of a video conferencing system to which an embodiment of the invention is adapted.

The video conferencing system shown in FIG. 1 is configured of video conferencing apparatuses 11a and 11b.

For example, the video conferencing apparatuses 11a and 11b are connected to each other through communication lines such as the Internet or a LAN (local area network), in which images and sounds are exchanged between the video conferencing apparatuses 11a and 11b for video conferencing.

In other words, for example, the video conferencing apparatuses 11a and 11b each send (the signals of) the taken images or sounds obtained by taking the scenes of a conference or by collecting sounds of speeches in the conference held in a conference room where these apparatuses are disposed to a communication partner video conferencing apparatus. In addition, the video conferencing apparatuses 11a and 11b receive taken images and sounds sent from the communication partner video conferencing apparatus, and output the images and sounds to a monitor and a speaker.

Moreover, hereinafter, in the case in which it is unnecessary to distinguish between the video conferencing apparatuses 11a and 11b, the video conferencing apparatuses 11a and 11b are simply referred to as the video conferencing apparatus 11.

FIG. 2 shows a block diagram depicting an exemplary configuration of a first embodiment of the video conferencing apparatus 11.

The video conferencing apparatus 11 shown in FIG. 2 is configured of a manipulating part 31, a CPU (Central Processing Unit) 32, a motor-operated pan head 33 that has a memory 33a incorporated therein, a camera 34, an image processing unit 35, a storage part 36, microphones 37 to 39 each having LEDs (Light Emitting Diodes) 37a to 39a, a sound processing unit 40, a communicating part 41, and an output part 42.

The manipulating part 31 is configured of a power button of the video conferencing apparatus 11. For example, when a user manipulates the manipulating part 31, the manipulating part 31 supplies a manipulation signal corresponding to the user manipulation to the CPU 32.

The CPU 32 executes a program stored in the storage part 36 to control the motor-operated pan head 33, the camera 34, the image processing unit 35, the microphones 37 to 39, the LEDs 37a to 39a, the sound processing unit 40, the communicating part 41, and the output part 42, and to perform various other processes.

In other words, for example, the manipulating part 31 supplies a manipulation signal to the CPU 32, and then the CPU 32 performs a process corresponding to the manipulation signal from the manipulating part 31.

Moreover, the CPU 32 supplies the taken images and sounds from the communication partner video conferencing apparatus 11a or 11b, which are supplied from the communicating part 41 to the output part 42 to output them.

In addition, the CPU 32 supplies the taken image after image processing from the image processing unit 35 and the sounds corresponding to the sound signals from the sound processing unit 40 to the communicating part 41 to send them to the communication partner video conferencing apparatus 11a or 11b.

Moreover, the CPU 32 performs various processes, described later, based on an LED image after image processing, described later, which is supplied from the image processing unit 35, and on the sound signals supplied from the sound processing unit 40.

In addition, the CPU 32 reads information stored in the storage part 36 as necessary, as well as supplies necessary information to the storage part 36 to store it.

The motor-operated pan head 33 rotationally drives the camera 34 provided on the motor-operated pan head 33 in the lateral direction or in the vertical direction, whereby it controls the attitude of the camera 34 so that a pan angle or a tilt angle as the imaging direction that is the imaging direction of the camera 34 becomes the pan angle or the tilt angle in a predetermined direction.

Here, the pan angle is an angle that indicates what degree the optical axis of the camera 34 is tilted in the lateral (horizontal) direction relative to the optical axis of the camera 34 when the camera 34 is set to a predetermined attitude (for example, a certain attitude in which the optical axis is orthogonal to the direction of the gravity). For example, in the case in which the optical axis of the camera 34 is tilted rightward at an angle of 10 degrees, the pan angle is an angle of +10 degrees, and in the case in which it is tilted leftward at an angle of 10 degrees, the pan angle is an angle of −10 degrees. In addition, the tilt angle is an angle that indicates what degree the optical axis of the camera 34 is tilted in the vertical (orthogonal) direction relative to the optical axis of the camera 34 when the camera 34 is set to a predetermined attitude. For example, in the case in which the optical axis of the camera 34 is tilted upward at an angle of 10 degrees, the tilt angle is an angle of +10 degrees, and in the case in which the optical axis of the camera 34 is tilted downward at an angle of 10 degrees, the tilt angle is an angle of −10 degrees.

In addition, the motor-operated pan head 33 has the memory 33a incorporated therein, and stores the latest pan angle and tilt angle of the camera 34 in the memory 33a as necessary in an overwrite manner.

The camera 34 is fixed to the motor-operated pan head 33 for imaging pictures in the attitude controlled by the motor-operated pan head 33. Then, the camera 34 uses a CCD (Charge Coupled Devices) or a CMOS (Complementary Metal Oxide Semiconductor) sensor to acquire images of the scenes of a conference held in a conference room or the like where the video conferencing apparatus 11 is disposed, for example, and the other images, and supplies the taken images to the image processing unit 35.

The image processing unit 35 subjects the taken images supplied from the camera 34 to image processing such as noise removal, and supplies the taken images after image processing to the CPU 32.

The storage part 36 is configured of a non-volatile memory, a HD (hard disk) or the like, for example, which stores information necessary to control the camera 34, including a reference position (x_{c}, y_{c}), thresholds Th_x and Th_y, imaging information, and a program executed by the CPU 32, for example, described later.

For example, the microphones 37 to 39 collect sounds of speeches in a conference held in a conference room or the like where the video conferencing apparatus 11 is disposed, convert the sounds into corresponding sound signals, and supplies them to the sound processing unit 40.

In addition, the microphones 37 to 39 have the LEDs 37a to 39a, respectively, and for example, the LEDs 37a to 39a emit lights in a predetermined light emission pattern under control done by the CPU 32. Moreover, the lights emitted from the LED 37a to 39a may be any lights as long as the lights can be imaged by the camera 34. For example, the lights may be visible lights that can be sensed by human eyes, or may be invisible lights such as infrared rays that are difficult to be sensed by human eyes.

Here, the taken image obtained by the camera 34 includes an image that takes the lights emitted from the LEDs 37a to 39a of the microphones 37 to 39, and this image is particularly referred to as an LED image.

The sound processing unit 40 subjects the sound signals supplied from the microphones 37 to 39 to sound processing such as an echo canceller that prevents echoes or howling, and supplies the sound signals after sound processing to the CPU 32.

The communicating part 41 receives the taken images and the sound signals sent from the communication partner video conferencing apparatus 11a or 11b, and supplies them to the CPU 32. In addition, the communicating part 41 sends the taken images and the sound signals supplied from the CPU 32 to the communication partner video conferencing apparatus 11a or 11b.

For example, the output part 42 is a display such as an LCD (Liquid Crystal Display) and a speaker, which displays the taken images supplied from the CPU 32 as well as outputs the sounds corresponding to the sound signals.

FIG. 3 shows a block diagram depicting an exemplary configuration of a control part 32a that is functionally implemented by the CPU 32 shown in FIG. 2 running the program stored in the storage part 36.

The control part 32a is configured of a light emission control part 100, a light emitting position detecting part 101, an error computing part 102, a determining part 103, a pan/tilt angle acquiring part 104, a pan/tilt angle computing part 105, a PTZ control part 106, and a sound level determining part 107.

The light emission control part 100 controls the LEDs 37a to 39a of the microphones 37 to 39, and allows the LEDs 37a to 39a to emit a light in a predetermined light emission pattern in a predetermined order, for example.

To the light emitting position detecting part 101, the image processing unit 35 supplies the taken images.

The light emitting position detecting part 101 detects a light emitting position (x, y) that is a position of the lights emitted from the LEDs 37a to 39a of the microphones 37 to 39 in the LED image among the taken images supplied from the image processing unit 35, and supplies the position to the error computing part 102.

In addition, hereinafter, the light emitting position (x, y) is represented by the coordinates of an XY-coordinates system shown on the upper side in the drawing, in which the upper left end of an LED image 131 supplied from the image processing unit 35 is an origin point (0, 0), and the right direction from the origin point (0, 0) is an X-axis as well as the downward direction is a Y-axis.

The error computing part 102 reads a reference position (x_{c}, y_{c}) stored in the storage part 36, computes error values x−x_{c} and y−y_{c} that indicate shifts between the reference position (x_{c}, y_{c}) and the light emitting position (x, y) supplied from the light emitting position detecting part 101 in the X-coordinate and the Y-coordinate, and supplies the values to the determining part 103.

Here, in the embodiment, for example, there is a premise that one attendee has a seat near a single microphone in such a way that the attendees of a video conference are three people (or below) that are equal to the number of the microphones 37 to 39 and one of the three attendees has a seat near the microphone 37, another one has a seat near the microphone 38, and the last one has a seat near the microphone 39.

Therefore, suppose now one of the attendees takes a seat near the microphone 37, for example, among the microphones 37 to 39. When the camera 34 shoots images so that the microphone 37 is seen at a certain position in taken images, such a taken image of the attendee sitting near the microphone 37 can be obtained in which attention is focused on the attendee. As described above, the reference position (x_{c}, y_{c}) is the position of the microphone 37 pictured in a taken image when the camera 34 can obtain that taken image in which attention is focused on the attendee sitting near the microphone 37.

The error computing part 102 considers the position of the LED 37a of the microphone 37, that is, the light emitting position (x, y) to be the position of the microphone 37, and determines the error between the light emitting position (x, y) and the reference position (x_{c}, y_{c}).

In addition, for the reference position (x_{c}, y_{c}), for example, the position at the center of the LED image 131 (the barycenter) can be adopted. Moreover, the reference position (x_{c}, y_{c}) can be changed in accordance with the manipulations of the manipulating part 31.

The determining part 103 calculates the absolute values of the error values x−x_{c} and y−y_{c} supplied from the error computing part 102 to determine the error absolute values |x−x_{c}| and |y−y_{c}|.

In addition, the determining part 103 reads the thresholds Th_x and Th_y used to determine whether the light emitting position (x, y) is positioned at (near) the reference position (x_{c}, y_{c}) out of the storage part 36 in which the thresholds Th_x and Th_y are stored.

Based on the error absolute values |x−x_{c}| and |y−y_{c}| that are the absolute values of the error values x−x_{c} and y−y_{c} and the thresholds Th_x and Th_y read out of the storage part 36, the determining part 103 determines whether the light emitting position (x, y) detected by the light emitting position detecting part 101 is matched with (regarded as) the reference position (x_{c}, y_{c}), that is, the determining part 103 determines whether the error absolute value |x−x_{c}| is smaller than the threshold Th_x and the error absolute value |y−y_{c}| is smaller than the threshold Th_y.

When it is determined that the light emitting position (x, y) is matched with the reference position (x_{c}, y_{c}), that is, the error absolute value |x−x_{c}| is smaller than the threshold Th_x and the error absolute value |y−y_{c}| is smaller than the threshold Th_y, the determining part 103 supplies the determined result according to the determination to the pan/tilt angle acquiring part 104.

On the other hand, when it is determined that the light emitting position (x, y) is not matched with the reference position (x_{c}, y_{c}), that is, the error absolute value |x−x_{c}| is equal to or greater than the threshold Th_x, or the error absolute value |y−y_{c}| is equal to or greater than the threshold Th_y, the determining part 103 supplies the determined result according to the determination and the error values x−x_{c} and y−y_{c} supplied from the error computing part 102 to the pan/tilt angle acquiring part 104.

The pan/tilt angle acquiring part 104 performs the process based on the determined result supplied from the determining part 103.

In other words, for example, in the case in which the light emitting position (x, y) that is the position of the LED 37a of the microphone 37 is now matched with the reference position (x_{c}, y_{c}), the determining part 103 supplies the determined result that the light emitting position (x, y) is matched with the reference position (x_{c}, y_{c}) to the pan/tilt angle acquiring part 104. In this case, the pan/tilt angle acquiring part 104 detects the pan angle and the tilt angle that indicate the imaging direction of the camera 34 stored in the memory 33a when the light emitting position (x, y) is matched with the reference position (x_{c}, y_{c}) as the pan angle and the tilt angle that indicate the arranging direction in which the microphone 37 having the LED 37a is disposed as seen from the camera 34, and supplies the angles as imaging information about the microphone 37 to the storage part 36 to store the angles in association with identification information that identifies the microphone 37.

Here, imaging information about a microphone is information used to control the camera 34 to take the attendee sitting near that microphone in a video conference.

On the other hand, in the case in which the light emitting position (x, y) that is the position of the LED 37a of the microphone 37 is not matched with the reference position (x_{c}, y_{c}), the determining part 103 supplies the determined result that the light emitting position (x, y) is not matched with the reference position (x_{c}, y_{c}) to the pan/tilt angle acquiring part 104. In this case, the pan/tilt angle acquiring part 104 reads the pan angle and the tilt angle that indicate the imaging direction of the camera 34 stored in the memory 33a out of the memory 33a, and supplies the angles to the pan/tilt angle computing part 105 together with the error values x−x_{c} and y−y_{c} supplied from the determining part 103.

Based on the pan angle, the tilt angle and the error values x−x_{c} and y−y_{c} supplied from the pan/tilt angle acquiring part 104, the pan/tilt angle computing part 105 computes the pan angle or the tilt angle as the imaging direction of the camera 34 in which the light emitting position (x, y) is matched with the reference position (x_{c}, y_{c}), and supplies the angel to the PTZ control part 106.

In other words, for example, in the case in which the error value x−x_{c} supplied from the pan/tilt angle acquiring part 104 to the pan/tilt angle computing part 105 is a positive value, that is, in the case in which, the light emitting position (x, y) is located in the right direction more than the reference position (x_{c}, y_{c}) is, the pan/tilt angle computing part 105 computes the pan angle of the camera 34 that can obtain an LED image in which the value x of the X-coordinate of the light emitting position (x, y) takes the value closer to the value x_{c} of the X-coordinate of the reference position (x_{c}, y_{c}) by adding an angle for rotational drive when the camera 34 is rotationally driven rightward at a predetermined angle to the pan angle supplied from the pan/tilt angle acquiring part 104.

In addition, for example, in the case in which the error value x−x_{c} supplied from the pan/tilt angle acquiring part 104 to the pan/tilt angle computing part 105 is a negative value, that is, in the case in which the light emitting position (x, y) is located in the left direction more than the reference position (x_{c}, y_{c}) is, the pan/tilt angle computing part 105 computes the pan angle of the camera 34 that can obtain an LED image in which the value x of the X-coordinate of the light emitting position (x, y) takes the value closer to the value x_{c} of the X-coordinate of the reference position (x_{c}, y_{c}) by subtracting an angle for rotational drive to rotationally drive the camera 34 leftward at a predetermined angle from the pan angle supplied from the pan/tilt angle acquiring part 104.

Moreover, for example, In the case in which the error value y−y_{c} supplied from the pan/tilt angle acquiring part 104 to the pan/tilt angle computing part 105 is a positive value, that is, in the case in which the light emitting position (x, y) is located in the downward direction more than the reference position (x_{c}, y_{c}) is, the pan/tilt angle computing part 105 computes the tilt angle of the camera 34 that can obtain an LED image in which the value y of the Y-coordinate of the light emitting position (x, y) takes a value closer to the value y_{c} of the Y-coordinate of the reference position (x_{c}, y_{c}) by subtracting an angle for rotational drive to rotationally drive the camera 34 downward at a predetermined angle from the tilt angle supplied from the pan/tilt angle acquiring part 104.

In addition, for example, in the case in which the error value y−y_{c} supplied from the pan/tilt angle acquiring part 104 to the pan/tilt angle computing part 105 is a negative value, that is, in the case in which the light emitting position (x, y) is located in the upward direction more than the reference position (x_{c}, y_{c}) is, the pan/tilt angle computing part 105 computes the tilt angle of the camera 34 that can obtain an LED image in which the value y of the Y-coordinate of the light emitting position (x, y) takes a value closer to the value y_{c} of the Y-coordinate of the reference position (x_{c}, y_{c}) by adding an angle for rotational drive to rotationally drive the camera 34 upward at a predetermined angle to the tilt angle supplied from the pan/tilt angle acquiring part 104.

The PTZ control part 106 controls the motor-operated pan head 33 so that the pan angle and the tilt angle that are the imaging direction of the camera 34 become the pan angle and the tilt angle supplied from the pan/tilt angle computing part 105.

In addition, to the PTZ control part 106, the sound level determining part 107 supplies identification information that identifies the microphones 37 to 39.

The PTZ control part 106 reads out of the storage part 36 imaging information about the microphone which is identified by identification information from the sound level determining part 107, and controls the motor-operated pan head 33 based on the imaging information. In other words, the PTZ control part 106 controls the motor-operated pan head 33 based on imaging information about the microphone read out of the storage part 36 so that the imaging direction of the camera 34 is the arranging direction of the microphone identified by identification information.

The sound level determining part 107 recognizes a microphone that supplies the sound signal at the maximum level (the sound signal at the loudest sound level), for example, among the microphones 37 to 39 based on the sound signal from the sound processing unit 40, and supplies identification information that identifies that microphone to the PTZ control part 106.

In other words, the sound processing unit 40 supplies the sound signals from the microphones 37 to 39 to the sound level determining part 107 through separate cables, for example. The sound level determining part 107 supplies identification information that identifies the microphone connected to the cable to which the sound signal at the loudest level is fed among the microphones 37 to 39 to the PTZ control part 106.

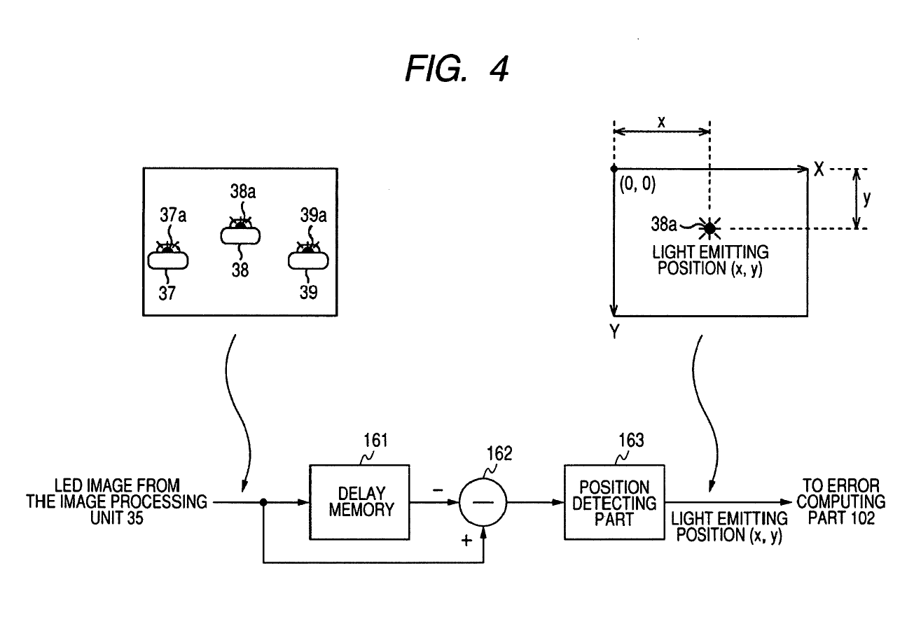

FIG. 4 shows a diagram illustrative of a light emitting position detecting process in which the light emitting position detecting part 101 shown in FIG. 3 detects the light emitting position (x, y).

The light emitting position detecting part 101 shown in FIG. 3 is configured of a delay memory 161, a subtracting part 162, and a position detecting part 163.

To the delay memory 161 and the subtracting part 162, the image processing unit 35 supplies taken images.

Here, in FIG. 4, for example, an LED image is a taken image that is imaged by the camera 34 taking the scenes in which the LED 38a of the microphone 38 emits lights (blinks) in a certain light emission pattern among the microphones 37 to 39, and the taken image is supplied from the image processing unit 35 to the delay memory 161 and the subtracting part 162 of the light emitting position detecting part 101.

The delay memory 161 temporarily stores an LED image supplied from the image processing unit 35 to delay the LED image by a time period for one frame, and then supplies it to the subtracting part 162.

Therefore, suppose the frame of the LED image supplied from the image processing unit 35 to the subtracting part 162 is considered to be a frame of interest. Then, when the image processing unit 35 supplies the LED image of the frame of interest to the subtracting part 162, the delay memory 161 supplies an LED image of the previous frame one frame before the frame of interest to the subtracting part 162.

The subtracting part 162 calculates the differences between the pixel values of the pixels of the LED image of the frame of interest supplied from the image processing unit 35 and the pixel values of the corresponding pixels of the LED image of the previous frame from the delay memory 161, and supplies a differential image that is an image having the obtained difference values as pixel values to the position detecting part 163.

The position detecting part 163 calculates the absolute values of the pixel values of the differential image supplied from the subtracting part 162, and then determines whether there are pixel values equal to or greater than a predetermined threshold in the differential image.

When it is determined that the differential image has pixel values equal to or greater than a predetermined threshold, the position detecting part 163 detects a position as the light emitting position (x, y) based on the pixel having the pixel value equal to or greater than a predetermined threshold, such as the position of a single pixel among the pixels or the position indicated by the X-coordinate and the Y-coordinate obtained from the mean of the X-coordinates and the Y-coordinates of all the pixels, and supplies the position to the error computing part 102 shown in FIG. 3.

In addition, in the light emitting position detecting process described with reference to FIG. 4, an LED of a predetermined microphone emits lights in a predetermined light emission pattern under control done by the light emission control part 100 in such a way that the light emitting position detecting part 101 shown in FIG. 3 easily detects the light emitting position (x, y) of the LED of the predetermined microphone from the LED image supplied from the image processing unit 35 shown in FIG. 2.

In other words, for example, in the case in which the camera 34 shown in FIG. 2 is a camera having the frame rate of 30 frames per second (60 fields per second) according to the NTSC (National Television System Committee) system and the camera 34 shown in FIG. 2 takes 30 frames of LED images for one second, the light emission control part 100 (the CPU 32) shown in FIG. 3 can control the light emission of an LED of a predetermined microphone in such a way that the light emitted from the LED of the predetermined microphone is pictured only in the even-numbered LED images, for example, among 30 LED images taken for one second by the camera 34 shown in FIG. 2.

In this case, by imaging done by the camera 34 shown in FIG. 2, the LED emitting no lights is pictured in the odd-numbered LED images among 30 LED images taken for one second, and the LED emitting lights is pictured in the even-numbered LED images.

Next, an arranging direction detecting process that detects the directions of arranging the microphones 37 to 39 will be described with reference to a flow chart shown in FIG. 5.

It is necessary to perform the arranging direction detecting process after the microphones 37 to 39 are newly set, or when the microphones 37 to 39 are set to perform the arranging direction detecting process for one time and then the positions of the microphones 37 to 39 are changed. For example, a user manipulates the manipulating part 31 (FIG. 2) to perform the arranging direction detecting process, and then the process is started.

In Step S31, the light emission control part 100 sets one microphone among the microphones 37 to 39 to a microphone of interest, and the process goes from Step S31 to Step S32. The light emission control part 100 controls the LED of the microphone of interest to emit lights in a predetermined light emission pattern, and then the process goes to Step S33.

Here, the control of the LED of the microphone of interest done by the light emission control part 100 may be performed by cables, or by radio.

In Step S33, the PTZ control part 106 rotationally drives the camera 34 in the lateral direction or in the vertical direction so as to image the lights emitted from the LED of the microphone of interest, and supplies taken images imaged by the camera 34 to the image processing unit 35.

The image processing unit 35 subjects the taken images supplied from the camera 34 to image processing such as noise removal, and supplies the images after image processing to the light emitting position detecting part 101 (the CPU 32).

The light emitting position detecting part 101 generates a differential image from the taken images from the image processing unit 35 as described in FIG. 4. Then, the light emitting position detecting part 101 obtains the differential image having the pixel value equal to or greater than a predetermined threshold, that is, it obtains the LED image in which the LED of the microphone of interest is pictured, and then the PTZ control part 106 stops the rotationally driven camera 34.

After that, the process goes from Step S33 to Step S34. The light emitting position detecting part 101 performs the light emitting position detecting process described in FIG. 4 to detect the light emitting position (x, y) of the LED of the microphone of interest in the LED image supplied from the image processing unit 35, and supplies it to the error computing part 102, and then the process goes to Step S35.

In Step S35, the error computing part 102 reads the reference position (x_{c}, y_{c}) stored in the storage part 36, and the process goes from Step S35 to Step S36. The error computing part 102 computes the error values x−x_{c} and y−y_{c} between the reference position (x_{c}, y_{c}) and the light emitting position (x, y) supplied from the light emitting position detecting part 101, and supplies the values to the determining part 103.

After the process step in Step S36 is finished, the process goes to Step S37. The determining part 103 calculates the absolute values of the error values x−x_{c} and y−y_{c} supplied from the error computing part 102 to determine the error absolute values |x−x_{c}| and |y−y_{c}|. In addition, in Step S37, the determining part 103 reads the thresholds Th_x and Th_y out of the storage part 36, and determines whether based on the error absolute values |x−x_{c}| and |y−y_{c}| and the thresholds Th_x and Th_y, the light emitting position (x, y) detected by the light emitting position detecting part 101 is matched with the reference position (x_{c}, y_{c}), that is, the error absolute value |x−x_{c}| is smaller than the threshold Th_x and the error absolute value |y−y_{c}| is smaller than the threshold Th_y.

In Step S37, if it is determined that the light emitting position (x, y) is not matched with the reference position (x_{c}, y_{c}), that is, if the error absolute value |x−x_{c}| is equal to or greater than the threshold Th_x, or the error absolute value |y−y_{c}| is equal to or greater than the threshold Th_y, the determining part 103 supplies the determined result that the light emitting position is not matched and the error values x−x_{c} and y−y_{c} supplied from the error computing part 102 to the pan/tilt angle acquiring part 104, and the process goes to Step S38.

The determining part 103 supplies the determined result that the light emitting position (x, y) is not matched with the reference position (x_{c}, y_{c}) In Step S38, the pan/tilt angle acquiring part 104 then reads the pan angle and the tilt angle stored in the memory 33a, that is, the pan angle and the tilt angle that indicate the current imaging direction of the camera 34, and supplies the angles as well as the error values x−x_{c} and y−y_{c} supplied from the determining part 103 to the pan/tilt angle computing part 105.

After that, the process goes from Step S38 to Step S39. Based on the pan angle, the tilt angle and the error values x−x_{c} and y−y_{c} supplied from the pan/tilt angle acquiring part 104, the pan/tilt angle computing part 105 computes the pan angle and the tilt angle that are the imaging direction of the camera 34 that obtains the LED image in which the light emitting position (x, y) is matched with the reference position (x_{c}, y_{c}), and supplies the angles to the PTZ control part 106, and then the process goes to Step S40.

In Step S40, the PTZ control part 106 controls the motor-operated pan head 33 so that the imaging direction of the camera 34 is the pan angle and the tilt angle supplied from the pan/tilt angle computing part 105, and the process returns to Step S33. The camera 34 images the lights emitted from the LED of the microphone of interest in accordance with the pan angle and the tilt angle controlled in Step S40, and supplies the resulted LED images to the image processing unit 35.

The image processing unit 35 subjects the LED images supplied from the camera 34 to image processing such as noise removal, and supplies the LED images after image processing to the light emitting position detecting part 101. The process goes from Step S33 to Step S34, and hereinafter, the similar process steps are repeated.

On the other hand, in Step S37, if it is determined that the light emitting position (x, y) is matched with the reference position (x_{c}, y_{c}), that is, if the error absolute value |x−x_{c}| is smaller than the threshold Th_x and the error absolute value |y−y_{c}| is smaller than the threshold Th_y, the determining part 103 supplies the determined result that the light emitting position is matched to the pan/tilt angle acquiring part 104, and the process goes to Step S41.

When the determining part 103 supplies the determined result that the light emitting position (x, y) is located at the reference position (x_{c}, y_{c}), in Step S41, the pan/tilt angle acquiring part 104 reads the pan angle and the tilt angle that are the current imaging direction of the camera 34 stored in the memory 33a as the pan angle and the tilt angle that identify the arranging direction of the microphone of interest, and supplies the angles as the imaging information about the microphone of interest to the storage part 36 to store the angles in association with identification information about the microphone of interest, and then the process goes to Step S42.

Here, after the imaging information about the microphone of interest is stored in the storage part 36, the light emission control part 100 stops the light emission of the LED of the microphone of interest.

In Step 342, the light emission control part 100 determines whether all the microphones 37 to 39 are set to the microphone of interest.

In Step S42, if it is determined that all the microphones 37 to 39 are not set to the microphone of interest, the process returns to Step S31. The light emission control part 100 newly selects one microphone that is not selected as the microphone of interest among the microphones 37 to 39 as the microphone of interest. The process goes to Step S32, and hereinafter, the similar process steps are repeated.

On the other hand, in Step S42, if it is determined that all the microphones 37 to 39 are set to the microphone of interest, the process is ended.

As discussed above, in the arranging direction detecting process shown in FIG. 5, the directions of arranging the microphones 37 to 39 are computed, and are stored as the items of imaging information of the microphones 37 to 39.

Consequently, in the video conferencing apparatus 11, it is unnecessary for a user to manually set the items of imaging information of the microphones 37 to 39 when the microphones 37 to 39 are newly arranged or when the arrangement of the microphones 37 to 39 is changed, whereby the user can be prevented from feeling that settings are burdensome.

In addition, even though the arrangement of the microphones 37 to 39 is changed, the arranging direction detecting process shown in FIG. 5 is again performed to flexibly cope with the changes in the arrangement of the microphones 37 to 39.

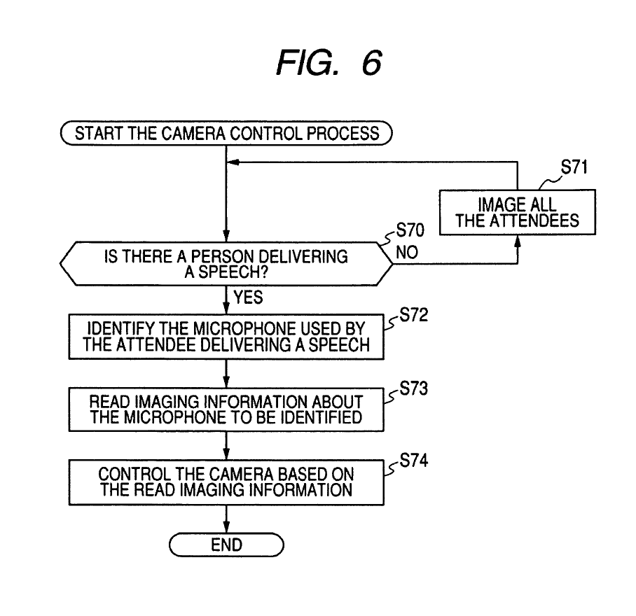

Next, a camera control process that controls the camera 34, which is performed in conducting a video conference by exchanging images and sounds between the video conferencing apparatuses 11a and 11b, will be described with reference to a flow chart shown in FIG. 6.

In addition, suppose a single microphone is allocated to each one of attendees attending at a video conference, and the attendee takes a seat near the microphone allocated to him/her among the microphones 37 to 39.

In addition, suppose the arranging direction detecting process described in FIG. 5 is already performed and ended.

In Step S70, the sound level determining part 107 determines whether there is a person who is delivering a speech (a speaker) among the attendees sitting near the microphones 37 to 39, that is, whether one of the attendees is delivering a speech.

In Step S70, if it is determined that no one is delivering a speech, that is, the sound processing unit 40 does not supply the sound signal at the level equal to or greater than a speech threshold for determining the deliver of a speech to the sound level determining part 107, the process goes to Step S71. The camera 34 is controlled in such a way that taken images are obtained that picture all of the three attendees in the video conference, and then the process returns to Step S70.

In other words, the PTZ control part 106 reads the items of imaging information of the three microphones 37 to 39 out of the storage part 36 to determine the imaging directions of the three microphones 37 to 39 pictured in the taken images, for example, from the imaging information, and controls the motor-operated pan head 33 in such a way that the camera 34 takes images in the imaging directions. Thus, the camera 34 images the taken images in which all of the three attendees near the three microphones 37 to 39 are pictured.

In addition, in Step S70, if it is determined that a speech is being delivered, that is, for example, one of the attendees sitting near the microphones 37 to 39 is delivering a speech and the voice of the speech is collected by the microphone near the attendee (speaker) delivering the speech and the resulted sound signals are supplied to the sound level determining part 107 through the sound processing unit 40, the process goes to Step S72. Based on the sound signals supplied from the sound processing unit 40, the sound level determining part 107 recognizes the microphone that supplies the sound signal at the maximum level among the microphones 37 to 39, for example, and supplies identification information that identifies the microphone to the PTZ control part 106.

In other words, in the case in which the sound signals at the level equal to or greater than a speech threshold are supplied from each of the microphones 37 to 39 to the sound level determining part 107 through the sound processing unit 40, the sound level determining part 107 supplies the identification information that identifies the microphone to the PTZ control part 106.

In addition, in the case in which the sound signals at the level equal to or greater than a speech threshold are supplied from a plurality of the microphones among the microphones 37 to 39 to the sound level determining part 107 through the sound processing unit 40, the sound level determining part 107 supplies the identification information that identifies the microphone collecting the sounds of the maximum level among the plurality of the microphones, for example, to the PTZ control part 106.

After the process step in Step S72 is finished, the process goes from Step S72 to Step S73. The PTZ control part 106 reads imaging information about the microphone identified by the identification information from the sound level determining part 107 out of the storage part 36, and then the process goes from Step S73 to Step S74. Based on the imaging information read out of the storage part 36, the PTZ control part 106 controls the motor-operated pan head 33 in such a way that the imaging direction of the camera 34 becomes the arranging direction of the microphone identified by the identification information from the sound level determining part 107, and then the process is ended.

As discussed above, in the camera control process shown in FIG. 6, based on imaging information about the microphone near a speaker, the motor-operated pan head 33 is controlled in such a way that the imaging direction of the camera 34 becomes the arranging direction of the microphone used by a speaker. Thus, the speaker can be imaged without manipulating the camera 34 by a user.

In addition, the light emitting position detecting process done by the light emitting position detecting part 101 shown in FIG. 3 can be easily implemented by calculating the differences between the LED images from the image processing unit 35. Therefore, such a function can be added to the existing video conferencing apparatus with no (little) costs for the additional function to perform the light emitting position detecting process.

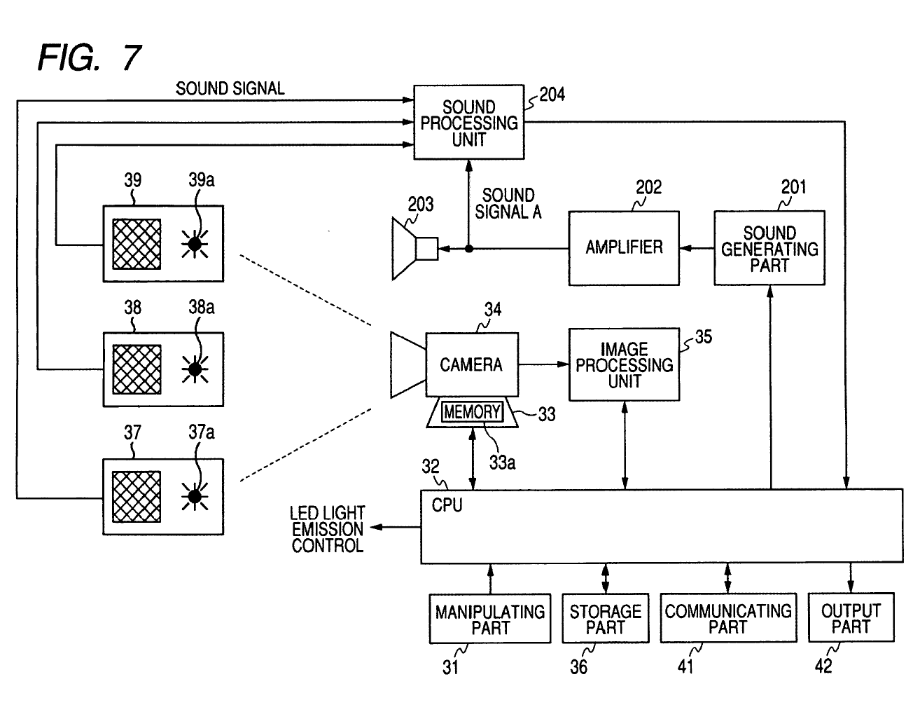

FIG. 7 shows a block diagram depicting an exemplary configuration of a second embodiment of the video conferencing apparatus 11 to which an embodiment of the invention is adapted.

In addition, in the drawing, the components corresponding to those shown in FIG. 2 are designated the same numerals and signs, and hereinafter the descriptions for those components are omitted properly.

In other words, the video conferencing apparatus 11 shown in FIG. 7 is provided with a sound processing unit 204 instead of the sound processing unit 40, which is similarly configured as that shown in FIG. 2, except that a sound generating part 201, an amplifier 202 and a speaker 203 are newly provided.

The sound generating part 201 generates a sound signal A used to calculate the distances between a camera 34 and microphones 37 to 39 under control done by a CPU 32, and supplies the distances to the amplifier 202. Here, for the sound signal A, for example, a sinusoidal wave at a predetermined frequency can be used.

The amplifier 202 amplifies the sound signal A supplied from the sound generating part 201 as necessary, and supplies it to the speaker 203 and the sound processing unit 204.

The speaker 203 is arranged near the camera 34, and outputs sounds corresponding to the sound signal A (after amplified) supplied from the amplifier 202.

To the sound processing unit 204, sound signals are supplied from the amplifier 202 and the microphones 37 to 39.

The sound processing unit 204 considers the sound signals from the microphone 37 to be a subject to perform sound processing of an echo canceller, and then detects the sound signal A contained in the sound signals from the microphone 37.

Then, the sound processing unit 204 sets a timing at which the sound signal A is supplied from the amplifier 202 to a timing at which (a predetermined sound corresponding to) the sound signal A is outputted from the speaker 203 as well as sets a timing of the sound signal A contained in the sound signals from the microphone 37 to a timing at which the sound signal A outputted from the speaker 203 is collected by the microphone 37, and supplies timing information that indicates the timing at which the sound signal A is outputted from the speaker 203 and the timing at which the sound signal A is collected by the microphone 37 to the CPU 32.

Similarly, to the CPU 32, the sound processing unit 204 supplies timing information that indicates the timing at which the sound signal A is outputted from the speaker 203 and a timing at which the sound signal A is collected by the microphone 38, and timing information that indicates the timing at which the sound signal A is outputted from the speaker 203 and a timing at which the sound signal A is collected by the microphone 39.

In addition, in FIG. 7, the storage part 36 stores a program different from one shown in FIG. 2, and the CPU 32 runs the program stored in the storage part 36 to perform the similar process to one shown in FIG. 2 as well as controls the sound generating part 201.

Moreover, the CPU 32 computes the distances between the speaker 203 and the microphones 37 to 39 from timing information supplied from the sound processing unit 204 (timing information that indicates the timing at which the sound signal A is outputted from the speaker 203 and the timing at which the sound signal A is collected by each of the microphones 37 to 39), and considers the distances to be the distances between the camera 34 disposed near the speaker 203 and the microphones 37 to 39 to control the magnification (the zooming factor) of the camera 34.

FIG. 8 shows a block diagram depicting an exemplary configuration of a control part 232a that is functionally implemented by the CPU 32 shown in FIG. 7 running the program stored in the storage part 36.

In addition, in the drawing, the components corresponding to the control part 32a shown in FIG. 3 are designated the same numerals and signs, and hereinafter the descriptions for those components are omitted properly.

In other words, the control part 232a shown in FIG. 8 is similarly configured as the control part 32a shown in FIG. 3 except that a distance computing part 301, and a zooming factor computing part 302 are newly provided.

To the distance computing part 301, timing information is supplied from the sound processing unit 204.

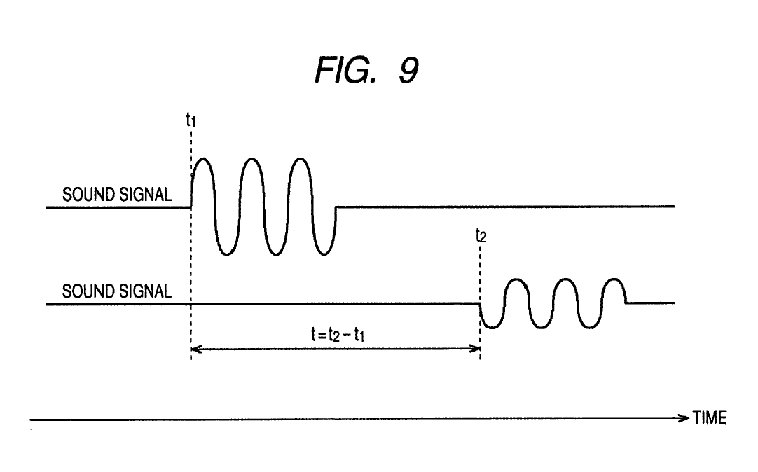

The distance computing part 301 computes the distances between the speaker 203 and the microphones 37 to 39 as the distances between the camera 34 and the microphones 37 to 39 from the timing information supplied from the sound processing unit 204, that is, from the timings at which the microphones 37 to 39 collect the sound signal A outputted from the speaker 203 and a timing at which the speaker 203 outputs the sound signal A, and supplies the distances to the zooming factor computing part 302. In addition, a specific method of computing the distances between the speaker 203 and predetermined microphones 37 to 39 by the distance computing part 301 will be described with reference to FIG. 9.

Based on the distances supplied from the distance computing part 301, the zooming factor computing part 302 computes the magnification of the camera 34 by which the size of the microphones 37 to 39 in the taken image obtained by the camera 34 becomes a predetermined size, which in turn results in the size of the attendees sitting near the microphones 37 to 39 becomes a predetermined size, and supplies the magnification to the storage part 36 to store it therein as a part of imaging information about the microphones 37 to 39.

Next, FIG. 9 shows a diagram illustrative of a method of computing the distance between the speaker 203 and each of the microphones 37 to 39 performed by the distance computing part 301 shown in FIG. 8.

In the drawing, the upper waveform shows the waveform of the sound signal supplied from the amplifier 202 to the sound processing unit 204, and the lower waveform shows the waveform of the sound signal supplied to the sound processing unit 204, for example, from the microphone 37 among the microphones 37 to 39.

To the distance computing part 301, the sound processing unit 204 supplies timing information that indicates a top timing t₁, for example, of the sound signal supplied from the amplifier 202 to the sound processing unit 204 and a top timing t₂, for example, of the sound signal supplied from the microphone 37 to the sound processing unit 204.

The distance computing part 301 subtracts the timing t₁ indicated by the timing information supplied from the sound processing unit 204 from the timing t₂ indicated by the timing information, and then computes the arrival time t=t₂−t₁ (s) that sounds outputted from the speaker 203 reach the microphone 37.

Moreover, the distance computing part 301 multiplies the value k (m/s) of the speed of sound stored in the storage part 36 (for example, 340 m/s) by the arrival time t (s) to compute the distance kt (m) between the speaker 203 and the microphone 37.

The distance computing part 301 similarly determines the distance between the speaker 203 and the microphone 38 or 39.

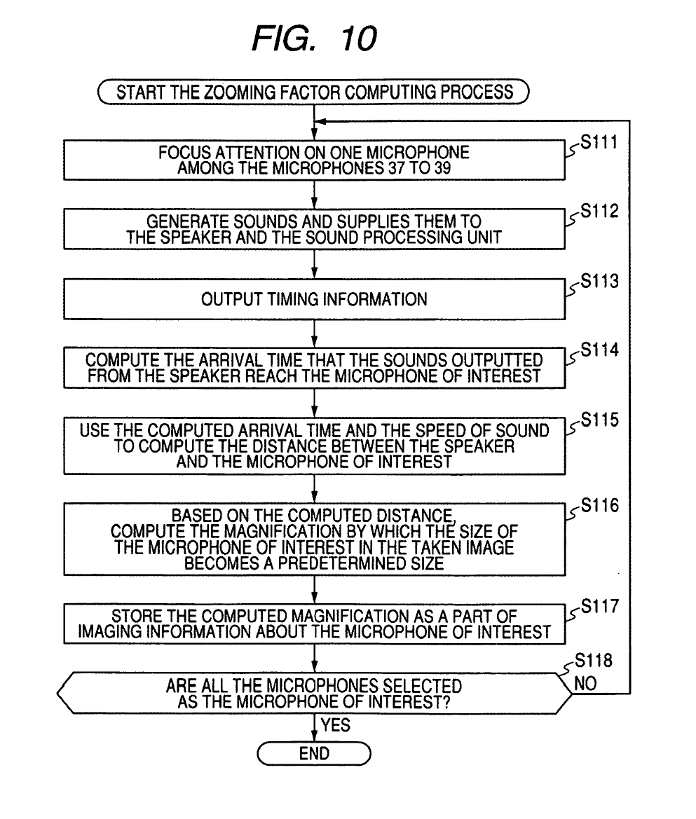

Next, a zooming factor computing process that computes the magnification of the camera 34 will be described with reference to a flow chart shown in FIG. 10 when the camera 34 takes images as the imaging direction thereof is the directions of arranging the microphones 37 to 39.

For example, the zooming factor computing process is performed right after the arranging direction detecting process shown in FIG. 5 is performed.

In Step S111, the distance computing part 301 selects one microphone among the microphones 37 to 39 to the microphone of interest, and the process goes to Step S112. The sound generating part 201 generates the sound signal A, and supplies it to the amplifier 202.

In addition, in Step S112, the amplifier 202 amplifies the sound signal A supplied from the sound generating part 201, and supplies it to the speaker 203 and the sound processing unit 204.

Thus, the speaker 203 outputs sounds corresponding to the sound signal A supplied from the amplifier 202, the sounds are collected by the microphone of interest, and the corresponding sound signals are supplied to the sound processing unit 204.

Then, the process goes from Step S112 to Step S113. The sound processing unit 204 determines the top timing t₁ of the sound signal A supplied from the amplifier 202 to the sound processing unit 204 and the too timing t₂ of the sound signal supplied from the microphone 37 to the sound processing unit 204, and supplies timing information that indicates the timings t₁ and t₂ to the distance computing part 301.

After that, the process goes from Step S113 to Step S114. The distance computing part 301 computes the arrival time t=t₂−t₁ (s) that the sounds outputted from the speaker 203 reach the microphone of interest from the timing information supplied from the sound processing unit 204, and the process goes to Step S115.

In Step S115, the distance computing part 301 multiplies the value k (m/s) of the speed of sound stored in the storage part 36 by the arrival time t (s) to compute the distance kt (m) between the speaker 203 and the microphone of interest, and supplies it to the zooming factor computing part 302.

After the process step in Step S115 is finished, the process goes to Step S116. The zooming factor computing part 302 considers the distance supplied from the distance computing part 301 to be the distance between the camera 34 and (the attendee sitting near) the microphone of interest, and based on the distance, the zooming factor computing part 302 computes the magnification of the camera 34 by which the size of the microphone of interest in the taken image obtained by the camera 34 becomes a predetermined size, that is, the size of the attendee's face near the microphone of interest becomes a predetermined size, and then the process goes to Step S117.

In Step S117, the zooming factor computing part 302 supplies the magnification computed in Step S116 just before to the storage part 36 to store it as a part of imaging information about the microphone of interest, and the process goes to Step S118.

In Step S118, the distance computing part 301 determines whether all the microphones 37 to 39 are selected as the microphone of interest.

In Step S118, if it is determined that all the microphones 37 to 39 are not yet selected as the microphone of interest, the process returns to Step S111. The distance computing part 301 newly selects one microphone that is not selected as the microphone of interest among the microphones 37 to 39 as the microphone of interest, the process goes to Step S112, and hereinafter, the similar process steps are repeated.

On the other hand, in Step S118, if it is determined that all the microphones 37 to 39 are selected as the microphone of interest, the process is ended.

As discussed above, in the zooming factor computing process shown in FIG. 10, the distances between the speaker 203 arranged near the camera 34 and the microphones 37 to 39 are considered to be the distances between the camera 34 and the microphones 37 to 39 for computation, and the distances are included in imaging information for storage. Thus, when the camera 34 takes images as the imaging direction of the camera 34 is the directions of arranging the microphones 37 to 39, the taken images can be obtained in which the attendees' faces near the microphones 37 to 39 are pictured in a suited size.

In other words, in the video conferencing apparatus 11 shown in FIG. 7, the camera control process similar to one described in FIG. 6 is performed. However, in Step S74, the PTZ control part 106 controls the motor-operated pan head 33 in such a way that the imaging direction of the camera 34 is the arranging direction contained in imaging information about the microphone identified by the identification information from the sound level determining part 107 as well as controls the camera 34 in such a way that the magnification of the camera 34 is the magnification contained in imaging information about the microphone identified by the identification information from the sound level determining part 107.

In addition, since the process that the sound processing unit 204 shown in FIG. 7 acquires the timings t₁ and t₂ indicated by timing information can be implemented by using the technique of the echo canceller generally performed, such a function can be added to the existing video conferencing apparatus with no (little) costs for the additional function to perform the process that acquires the timings t₁ and t₂ indicated by timing information.

Here, in the video conferencing apparatus 11 shown in FIG. 3, it is configured in which based on the lights emitted from the LEDs 37a to 39a of the microphones 37 to 39, the arranging directions of the microphones 37 to 39 are computed, and based on the arranging directions, the camera 34 is controlled. For example, based on the light emission pattern of the lights emitted from the LED, the camera can be controlled.

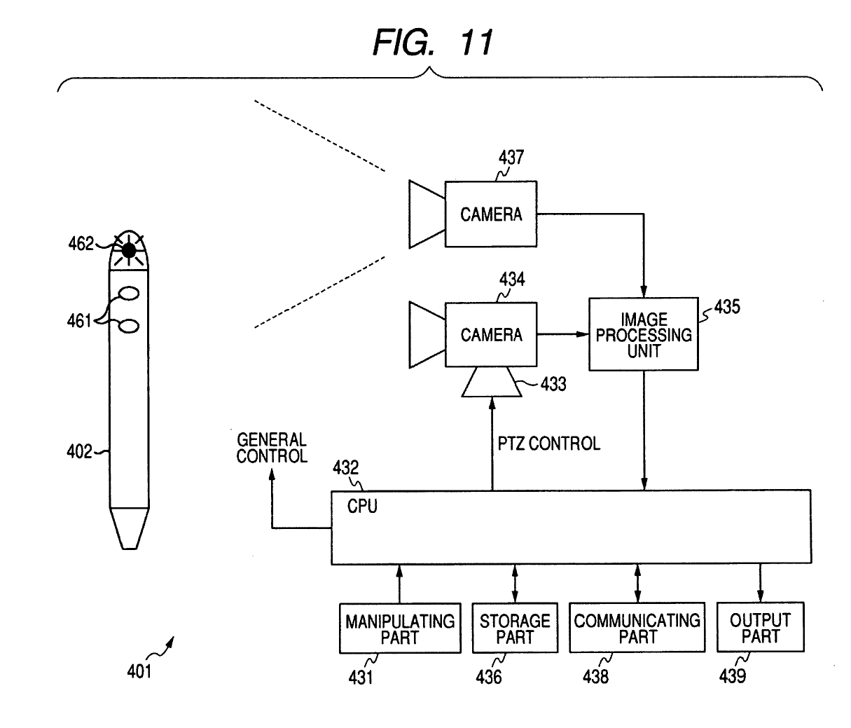

FIG. 11 shows a diagram depicting a video conferencing apparatus 401 and a directing device 402 that controls the video conferencing apparatus 401 based on the light emitted from an LED.

The video conferencing apparatus 401 is configured of a manipulating part 431, a CPU 432, a motor-operated pan head 433, a camera 434, an image processing unit 435, a storage part 436, a camera 437, a communicating part 438, and an output part 439.

The manipulating part 431 is configured of a power button of the video conferencing apparatus 401. For example, when a user manipulates the manipulating part 431, the manipulating part 431 supplies a manipulation signal corresponding to the user's manipulation to the CPU 432.

The CPU 432 runs a program stored in the storage part 436 to control the motor-operated pan head 433, the camera 434, the image processing unit 435, the camera 437, the communicating part 438, and the output part 439, and to perform various other processes.

In other words, for example, when the manipulating part 431 supplies the manipulation signal, the CPU 432 performs the process corresponding to the manipulation signal from the manipulating part 431.

Moreover, the CPU 432 supplies the taken images from a communication partner video conferencing apparatus, which are supplied from the communicating part 438, to the output part 439 for display.

In addition, the CPU 432 supplies the taken images after image processing, which are supplied from the image processing unit 435 to the communicating part 438 to send the images to the communication partner video conferencing apparatus.

Moreover, based on the LED images after image processing, which are supplied from the image processing unit 435, the CPU 432 controls the motor-operated pan head 433 and the camera 434.

In addition, the CPU 432 reads information stored in the storage part 436 out of the storage part 436, as necessary.

The motor-operated pan head 433 rotationally drives the camera 434 in the lateral direction or in the vertical direction provided on the motor-operated pan head 433, whereby it controls the attitude of the camera 434 so that a pan angle or a tilt angle as the imaging direction that is the imaging direction of the camera 34 becomes the pan angle or the tilt angle in a predetermined direction.

The camera 434 is fixed to the motor-operated pan head 433 for imaging pictures in the attitude controlled by the motor-operated pan head 433. Then, for example, the camera 434 uses a CCD or a CMOS sensor to acquire images of the scenes of a conference held in a conference room where the video conferencing apparatus 11 is disposed and the other taken images, and supplies the images to the image processing unit 435.

The image processing unit 435 subjects the taken images supplied from the camera 434 and the LED images that take the lights emitted from the directing device 402, which are supplied from the camera 437, to image processing such as noise removal, and the taken images and the LED images after image processing to the CPU 432.

For example, the storage part 436 is configured of a non-volatile memory, a hard disk or the like, and based on the lights emitted from the directing device 402, the storage part 436 stores therein information necessary to control the motor-operated pan head 433 and the camera 434, the program run by the CPU 432 and the like. In addition, for example, in the storage part 436, necessary information can be stored in accordance with the manipulations of the manipulating part 431.

For example, the camera 437 is fixed at the position at which the entire conference room disposed with the video conferencing apparatus 401 can be taken for imaging the entire conference room. Then, the camera 437 uses a CCD or a CMOS sensor to acquire LED images in which the lights emitted from an LED 462 of the directing device 402 are taken, and supplies the images to the image processing unit 435.

The communicating part 438 receives the taken images sent from the communication partner video conferencing apparatus, and supplies the images to the CPU 432. In addition, the communicating part 438 sends the taken images supplied from the CPU 432 to the communication partner video conferencing apparatus.

For example, the output part 439 is a display such as an LCD, which displays the taken images supplied from the CPU 432 thereon.

The directing device 402 that controls the video conferencing apparatus 401 is configured of a manipulating part 461 and the LED 462.

For example, the manipulating part 461 is configured of setting buttons to set the imaging direction and the magnification of the camera 434, and buttons to turn on and off the power source of the microphone incorporated in the camera 434.

The LED 462 emits lights in a certain light emission pattern. In other words, for example, when a user manipulates the manipulating part 461, the LED 462 emits lights in a light emission pattern corresponding to the manipulation. In addition, the lights emitted from the LED 462 may be any lights as long as the camera 437 can take these lights. For example, the lights may be visible lights that can be sensed by human eyes, or may be invisible lights such as infrared rays that are difficult to be sensed by human eyes.

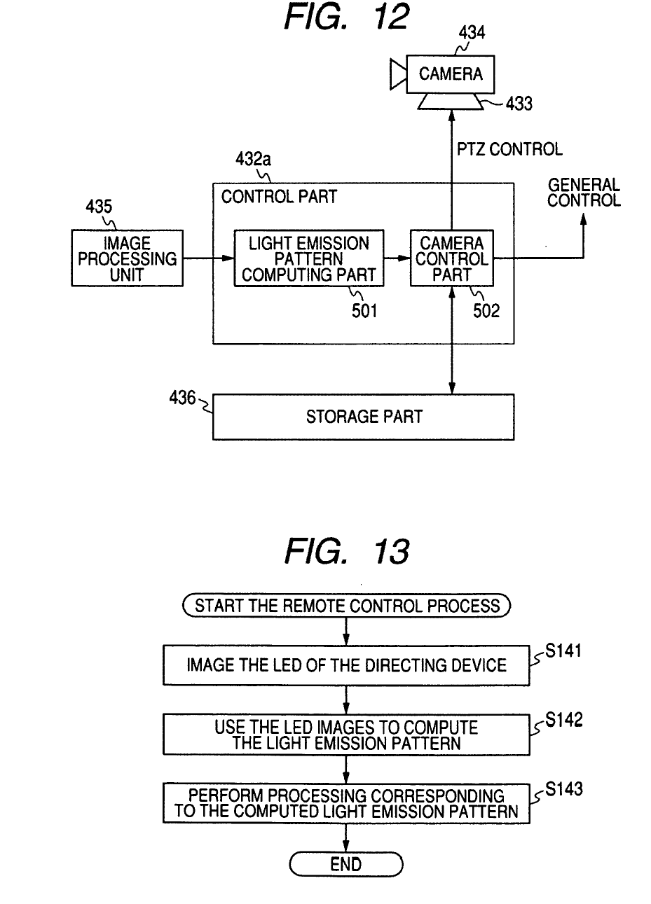

FIG. 12 shows a block diagram depicting an exemplary configuration of a control part 432a that is functionally implemented by the CPU 432 shown in FIG. 11 running the program stored in the storage part 436.

The control part 432a is configured of a light emission pattern computing part 501 and a camera control part 502.

To the light emission pattern computing part 501, the image processing unit 435 supplies LED images.

The light emission pattern computing part 501 computes the light emission pattern of the LED 462 of the directing device 402 from the LED images supplied from the image processing unit 435, and supplies pattern information that indicates the light emission pattern to the camera control part 502.

In addition, for a method of computing the light emission pattern, for example, in the case in which the camera 437 takes 30 LED images for one second, it is detected which LED image has the lighting LED 462 among the 30 LED images, whereby the light emission pattern of the LED 462 is computed.

The camera control part 502 reads a corresponding table stored in the storage part 436 out of the storage part 436. In addition, based on the corresponding table read out of the storage part 436, the camera control part 502 determines an instruction corresponding to the pattern information supplied from the light emission pattern computing part 501, and then controls the motor-operated pan head 433 and the camera 434 based on the instruction.

Here, the corresponding table is a table that associates pattern information that is computed by the light emission pattern computing part 501 to indicate the light emission pattern with an instruction to control the motor-operated pan head 433 and the camera 434 corresponding to the pattern information.

Next, a remote control process that remotely controls the video conferencing apparatus 401 based on the light emission pattern of the lights emitted from the LED 462 of the directing device 402 will be described with reference to a flow chart shown in FIG. 13.

For example, the remote control process is started when a user directs the imaging direction of the camera 434 to the user him/herself as well as manipulates the manipulating part 461 of the directing device 402 so that the user him/herself is zoomed in or out at a predetermined magnification.

At this time, the LED 462 of the directing device 402 emits lights in accordance with the light emission pattern corresponding to the manipulation of the manipulating part 461 by the user.

In Step S141, the camera 437 takes the lights emitted from the LED 462 of the directing device 402, and supplies the resulted LED images to the image processing unit 435.

The image processing unit 435 subjects the LED images supplied from the camera 437 to image processing such as noise removal, and supplies the LED images after image processing to the light emission pattern computing part 501 (the CPU 432).

After that, the process goes from Step S141 to Step S142. The light emission pattern computing part 501 computes the light emission pattern of the lights emitted from the LED 462 of the directing device 402 from the LED images supplied from the image processing unit 435 after image processing, and supplies pattern information that indicates the light emission pattern to the camera control part 502, and the process goes to Step S143.

In Step S143, the camera control part 502 reads the corresponding table stored in the storage part 436 out of the storage part 436, determines an instruction corresponding to the pattern information supplied from the light emission pattern computing part 501, and based on the instruction, the camera control part 502 controls the motor-operated pan head 433 and the camera 434. For example, the camera control part 502 directs the imaging direction of the camera 434 to the user as well as zooms in or out the user at a predetermined magnification. Thus, since the imaging direction of the camera 434 is directed to the user in accordance with the manipulation of the manipulating part 461 by the user as well as the user is zoomed in or out at a predetermined magnification, such a function can be easily implemented that the user is taken in a predetermined imaging direction in a predetermined size.

After that, the process is ended.

As discussed above, in the remote control process shown in FIG. 13, it is configured in which based on the light emission pattern of the lights emitted from the LED 462 of the directing device 402, the video conferencing apparatus 11 is remotely controlled. For example, even though a user is located at the position apart from the video conferencing apparatus 11, the video conferencing apparatus 11 can be easily operated without manipulating the manipulating part 431 of the video conferencing apparatus 11 located at the position apart from the user.

In addition, since the process that computes the light emission pattern of the light emission pattern computing part 501 shown in FIG. 12 can be readily implemented by calculating the difference between the LED images from the image processing unit 435, such a function can be added to the existing video conferencing apparatus before with no (little) costs for the additional function to perform the process of computing the light emission pattern.

In addition, it is configured in which series of the process steps of the arranging direction detecting process shown in FIG. 5, the camera control process shown in FIG. 6, the zooming factor computing process shown in FIG. 10, and the remote control process shown in FIG. 13 are conducted by allowing the CPU 32 or the CPU 432 to run the program, but the process steps can also be implemented by dedicated hardware.

The program run by the CPU 32 or the CPU 432 is stored in the storage part 36 or the storage part 436 in advance. In addition to this, for example, the program can be stored on a removable medium that is a package medium such as a magnetic disk (including a flexible disk), an optical disk (including a CD-ROM (Compact Disc-Read Only Memory), and a DVD (Digital Versatile Disc)), a magneto-optical disk, or a semiconductor memory, or the program can be provided over cable or radio networks such as the Internet.

In addition, in the specification, the steps describing the program to be recorded on the program recording medium of course include the process steps performed in time series along the described order and also include the process steps performed individually or in parallel not necessarily processed in time series.

Moreover, in the specification, the system represents the overall apparatuses configured of a plurality of devices.

In addition, in the arranging direction detecting process shown in FIG. 5, it is configured in which the microphones 37 to 39 are in turn selected as the microphone of interest, and the LED of the microphone of interest is allowed to emit lights in a predetermined light emission pattern to compute the arranging direction of the microphone of interest. For example, this scheme may be possible in which the LEDs 37a to 39a of the microphones 37 to 39 are allowed to emit lights in the individual light emission patterns at the same time to detect the directions of arranging the microphones 37 to 39.

In this case, a time period necessary to perform the arranging direction detecting process can be shortened more than the case in which the LEDs 37a to 39a of the microphones 37 to 39 are in turn allowed to emit lights.

Moreover, in the embodiments shown in FIGS. 2 and 7, it is configured in which the same camera 34 is used for the camera to take LED images as the taken images used in the arranging direction detecting process shown in FIG. 5 and for the camera to be a subject of control with imaging information in the camera control process shown in FIG. 6. However, the camera to take the LED images and the camera to be a subject of control with imaging information may be separate cameras.

In this case, desirably, the camera to take the LED images is placed near the camera to be a subject of control with imaging information. In addition, the camera to take the LED images may be a low resolution camera to take the LED images, and the camera to be a subject of control with imaging information may be a high resolution camera for taken images. In this case, since the arranging direction detecting process shown in FIG. 5 can be conducted for low resolution LED images, the amount of processing can be reduced.

In addition, the imaging direction of the camera 34 can be changed by providing a so-called hysteresis.

In other words, for example, in the case in which the attendees sitting near the microphones 37 to 39 are arguing, the microphones supplying the sound signal at the highest level are frequently changed. When the imaging direction of the camera 34 is varied every time when the microphones supplying the sound signal at the highest level are changed, the taken images are images difficult to see with rough motions. Then, for example, in the case in which the imaging direction of the camera 34 is not varied quickly even though the microphone supplying the sound signal at the highest level is changed from a microphone #1 to a microphone #2 and this situation is continued for a predetermined time period in which the microphone supplying the sound signal at the highest level is the microphone #2, the imaging direction of the camera 34 can be varied to the microphone #2. In this case, this event can be prevented that the taken images are images difficult to see because the imaging direction of the camera 34 is changed frequently.

Moreover, in the case in which the microphone supplying the sound signal at the highest level is changed between a plurality of the microphones among the microphones 37 to 39, the imaging direction of the camera 34 may be controlled so that all of the plurality of the microphones are pictured.

In addition, in the embodiment shown in FIG. 7, it is configured in which based on the distances between the camera 34 and the microphones 37 to 39, the magnification of the camera 34 is controlled. In addition to this, for example, the magnification of the camera 34 can be controlled in such a way that the area of the attendee's face pictured in a taken image is detected, and the area is occupied at a predetermined ratio of the number of pixels in the taken image.

Moreover, in the embodiments shown in FIGS. 2 and 7, it is configured in which only a single camera 34 is provided as the camera to take the attendees of a video conference who are subjects for control with imaging information. However, a plurality of cameras can be provided as the cameras to take the attendees of a video conference who are subjects for control with imaging information. For example, in the case in which two cameras are provided as the cameras to take the attendees of a video conference who are subjects for control with imaging information, this scheme may be possible in which one camera takes one attendee and the other camera takes another attendee when two attendees are arguing.

In addition, in the embodiments shown in FIGS. 2 and 7, it is configured in which the light emission control part 100 controls the light emission of the LEDs 37a to 39a. However, for example, a user may manipulate a switch or the like to allow the LEDs 37a to 39a to emit lights in a predetermined light emission pattern.

Next, in the video conferencing apparatus 401 shown in FIG. 11, it is configured in which the camera 437 is used as the camera to take the LED images used in the remote control process shown in FIG. 13 and the camera 434 is used as the camera to take the taken images. For example, the camera to take the LED images and the camera to take the taken images may be the same camera. In addition, in the case in which the camera to take the LED images and the camera to take the taken images are the same camera, desirably, the camera may be a wide angle, high resolution camera.

Moreover, in the directing device 402 shown in FIG. 11, it is configured in which the directing device 402 allows the LED 462 to emit lights to allow the video conferencing apparatus 401 to perform the process corresponding to the light emission pattern of the LED 462. For example, suppose this is configured such that a user allows the LED 462 to emit lights, and in this state, the trace of the lights emitted from the LED 462, which can be obtained by moving the directing device 402 having the LED 462, is detected by the video conferencing apparatus 401. With this configuration, the video conferencing apparatus 401 can be provided with a marking function.

In other words, for example, the video conferencing apparatus 401 can mark the trace of the lights in the taken images by superimposing (combining) the trace of the detected lights with the taken images imaged by the camera 434. Therefore, for example, a predetermined object in the taken image is marked to point out the predetermined object.

More specifically, in the video conferencing apparatus 401, for example, the taken image obtained by the camera 434 is superimposed with the trace of a circle encircling the area of interest in which conference materials are taken in the taken image, and the taken image emphasizing the area of interest can be generated.

In addition, in the remote control process shown in FIG. 13, it is configured in which the directing device 402 allows the LED 462 to emit lights to allow the video conferencing apparatus 401 to perform the process corresponding to the light emission pattern of the lights emitted from the LED 462. For example, suppose the CPU 432 performs the arranging direction detecting process shown in FIG. 5 as the lighting LED 462 is a subject. The arranging direction of the LED 462 can be computed, in which the light emitting position (x, y) of the LED 462 is located at the reference position (x_{c}, y_{c}). Therefore, the imaging direction of the camera 434 is set so as to be the computed arranging direction, whereby the camera 434 can be directed to the direction of the directing device 402 having the LED 462.

In addition, the embodiment of the invention is not limited to the embodiments described above, which can be modified within the scope not deviating from the teaching of an embodiment of the invention.

It should be understood by those skilled in the art that various modifications, combinations, sub-combinations and alterations may occur depending on design requirements and other factors insofar as they are within the scope of the appended claims or the equivalents thereof.

What is claimed is:

1. A video conferencing apparatus for video conferencing, comprising:
a light emission control means for allowing a light emitting means for emitting a light that is included in a sound collecting means for collecting a sound to emit a light in a certain light emission pattern;
a light emitting position detecting means for detecting a light emitting position that is a position of the light in an image obtained by imaging the light from the light emitting means included in the sound collecting means by a first imaging means for imaging;
an arranging direction detecting means for detecting an arranging direction that is a direction in which the sound collecting means is arranged based on the light emitting position; and
an imaging control means for controlling an imaging direction that is a direction in which a second imaging means for imaging an image takes an image, based on the arranging direction.

2. The video conferencing apparatus according to claim 1,
wherein the first imaging means images a low resolution image, and
the second imaging means images a high resolution image.

3. The video conferencing apparatus according to claim 1,
wherein the first and second imaging means are the same.

4. The video conferencing apparatus according to claim 1,
wherein the light emission control means allows each of a plurality of the light emitting means that is included in the sound collecting means to emit a light in a predetermined order, or allows each of a plurality of the light emitting means that is included in the sound collecting means to emit a light in individual light emission patterns simultaneously,
the light emitting position detecting means detects the light emitting position for each of the plurality of the sound collecting means,
the arranging direction detecting means detects the arranging direction of each of the plurality of the sound collecting means, based on the light emitting position, and
the imaging control means controls the imaging direction based on the arranging direction of a sound collecting means that is collecting a sound at a high level among the plurality of the sound collecting means.

5. The video conferencing apparatus according to claim 1, further comprising:
a distance computing means for computing a distance between a sound outputting means for outputting a predetermined sound and the sound collecting means based on a timing at which the sound collecting means collects a predetermined sound that is outputted from the sound outputting means and a timing at which the sound outputting means outputs the predetermined sound,
wherein the imaging control means also controls a magnification at the time of imaging by the second imaging means based on a distance between the sound outputting means and the sound collecting means.

6. The video conferencing apparatus according to claim 1, wherein one or more of the sound collecting means, the first imaging means, and the second imaging means is provided in plural.

7. A method of controlling a video conferencing apparatus for video conferencing, the method comprising the steps of:
allowing a light emitting means for emitting a light that is included in a sound collecting means for collecting a sound to emit a light in a certain light emission pattern;
detecting a light emitting position that is a position of the light in an image obtained by the light from the light emitting means included in the sound collecting means by a first imaging means for imaging; and
detecting an arranging direction that is a direction in which the sound collecting means is arranged based on the light emitting position,
wherein in the video conferencing apparatus, an imaging direction that is a direction in which a second imaging means for imaging an image takes an image is controlled based on the arranging direction.

8. A program that allows a computer to function as a video conferencing apparatus for video conferencing, the program allowing the computer to function as:
a light emission control means for allowing a light emitting means for emitting a light that is included in a sound collecting means for collecting a sound to emit a light in a certain light emission pattern;
a light emitting position detecting means for detecting a light emitting position that is a position of the light in an image obtained by imaging the light from the light emitting means included in the sound collecting means by a first imaging means for imaging;
an arranging direction detecting means for detecting an arranging direction that is a direction in which the sound collecting means is arranged based on the light emitting position; and
an imaging control means for controlling an imaging direction that is a direction in which a second imaging means for imaging an image takes an image, based on the arranging direction.

9. A video conferencing apparatus for video conferencing, comprising:
a light emission control unit configured to allow a light emitting unit included in a sound collecting unit to emitting a light in a certain light emission pattern;
a light emitting position detecting unit configured to detect a light emitting position that is a position of the light in an image obtained by imaging the light from the light emitting unit by a first imaging unit;
an arranging direction detecting unit configured to detect an arranging direction that is a direction in which the sound collecting unit is arranged based on the light emitting position; and
an imaging control unit configured to control an imaging direction that is a direction in which a second imaging unit takes an image, based on the arranging direction.
